(19) United States
(12) Patent Application Publication
(10) Pub. No.: US 2008/0018455 A1
(43) Pub. Date: Jan. 24, 2008

(54) Rfid Modular Reader

(76) Inventor: Henryk Kulakowski, Stalowa Wola (PL)

Correspondence Address: ROBERTS, MLOTKOWSKI & HOBBES, P. O. BOX 10064, MCLEAN, VA, 22102-8064, US

(21) Appl. No.: 11/570,877

(22) PCT Filed: Jun. 17, 2005
(86) PCT No.: PCT/PL05/00040

§ 371 Date: Mar. 26, 2007

(30) Foreign Application Priority Data
Jun. 17, 2004 (PL) P-368574

(51) Int. Cl. G08B 13/14; H04Q 7/00

(52) U.S. Cl. 340/539.11

(57) ABSTRACT

The RFID modular reader for reading out and, optionally, recording information in the n on-contact RFID cards, using portable devises as the central unit, is characteristic of modular structure, comprising the (O) casing for (U) portable unit, containing the (C) replaceable reader module, connected thereto, along with the (A) antennae, optionally with the (K) small flap, protecting the (U) portable devise as well as connected with the (O) casing by means of the (R) handle (T) grip, holding the container for (B) batteries and (P) switches.

### FIELD OF THE INVENTION

The subject of the invention is the RFID modular reader allowing for reading out and—optionally—recording data through radio system in the RFID cards.

### BACKGROUND OF THE INVENTION

The RFID (Radio Frequency Identification) is a technology enabling the remote readout and record of the data in the memory cards, using radio waves, simultaneously as information medium as well as the medium for the power supplying such a memory.

A lot of devises are known that allow for the readout/record of the information in the RFID cards. The most common are the stationary readers, assembled, e.g., at doors, cash-desks, belt conveyor flights. The WO02063545 invention may provide an example of these.

The manual readers are also quite known, built in the form of portable minicomputers, which is described by the JP2001155120 invention, equipped with the RFID reader elements. In most cases, they are used in industrial applications, and that is why their casings are specially strengthened and the devices themselves are fairly heavy.

In the WO03067539 invention, the RFID reader is a part of the casing. Owing to which it may operate as an extension of a cell phone.

The characteristic feature of the majority of devices is their certain completeness, in which—apart from the RFID elements—there is also a central unit, e.g. a microcomputer or a cell phone. Such a solution increases the costs of the entire device significantly and its functionality is limited to the concrete application only.

### SUMMARY OF THE INVENTION

The RFID modular reader for reading out and optionally—recording information in no—contact RFID cards, using portable devises, used in a device/reader as a central unit, according to the invention, is of modular structure consisting of a casing for portable device, containing the reader module connected thereto, along with an antennae, or optionally, a small flap protecting the portable device as well as connected with the casing by means of a handle grip holding the container for batteries and switches.

Optionally, the grip is movable and allows for the handle location regulation in relation to the casing.

In the reader, according to the invention, the antenna is fixed in the small flap.

The batteries, according to the invention, supply the RFID reader and optionally the portable device.

Optionally, the casing simultaneously contains the portable device extension sockets.

The reader, according to the invention, is equipped in additional joints allowing for connection to the computer, external supply source, or stands with such terminals.

In a preferred manner and additionally, there are additional light-emitting diodes in the casing, indicating the module operation condition or mode.

The portable devise is made up of the PDA type devise, the cell phone or smartphone, each equipped in joints allowing for connecting the external devices.

Optionally, the casing contains a replaceable insert, adjusted to the type of the portable device used. However, the insert optionally contains the extension sockets.

The advantage of the solution, according to the invention, is the fact that the RFID reader is an extension of the mobile devises available on the market, so it may be deemed as belonging to the group of accessories for such devices. The modular structure enables its adjustment to different mobile devices and the external supply source does not force the necessity to load the mobile device battery.

Another advantage of the invention is the reader modular structure, owing to which it allows for cooperation with various portables devises models. The application of the portable devises, widely available on the market, lowers the price of the entire device and simplifies its software and usage.

After taking out from the reader casing, the portable devise may be used for other purposes. The operation of the portable device extension sockets enables the usage of other extensions, e.g. wireless communication modules, which increases the possibilities of the entire reader by means of widely available extensions. Using the additional handle, facilitates comfortable grip and, at the same time, storing the additional battery supplying the device. Such a solution is both ergonomic and energy-saving, since the supply is switched on by a special handle button.

### BRIEF DESCRIPTION OF THE DRAWINGS

The subject of the invention is depicted in the drawing, in which

FIG. 1 presents the subject of the invention as seen from the front, where the C reader, along with t he A antennae is integrated in the O casing, the K small flap opens sideway, whereas the R adjustable handle, containing the B batteries, is connected with the O casing by one T grip only.

FIG. 2 presents the subject of the invention with the connected U portable devise, as seen from the front, in which the A antennae has been integrated in the K small flap, whereas the C reader and G extension sockets in the O casing that is connected with two T grips with the R handle, equipped with P buttons and D light emitting diode.

FIG. 3 presents the subject of the invention as seen from the bottom, where the W replaceable insert has bee marked and the 0 casing, connected by the T grip with R handle.

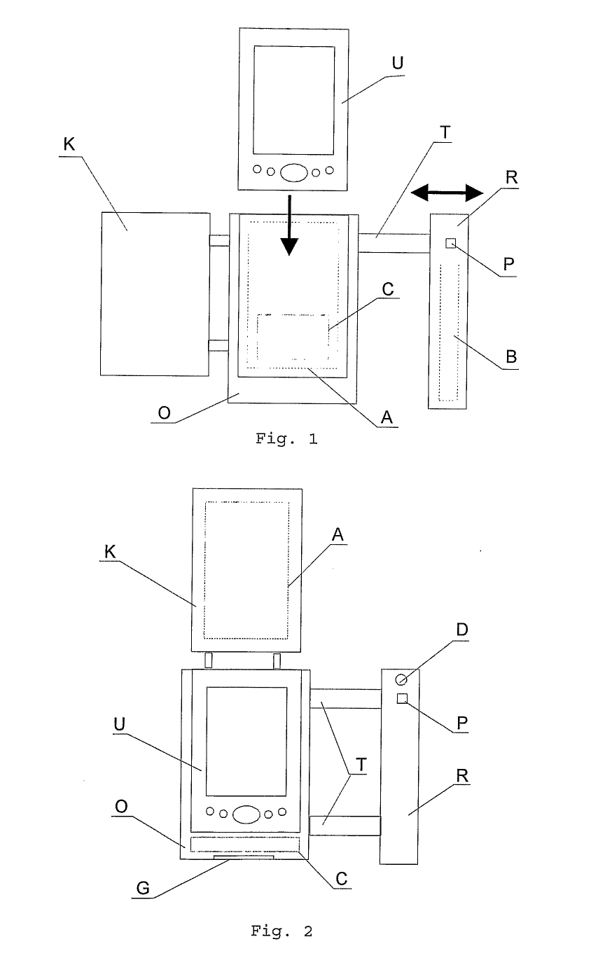

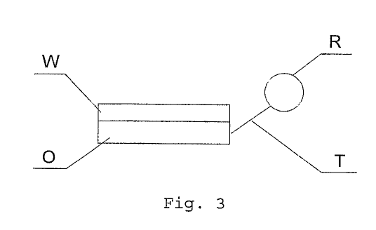

### DETAILED DESCRIPTION OF THE PREFERRED EMBODIMENTS

In accordance with the invention, the RFID modular reader is equipped with the O casing, in which the C reader and A antennae are integrated. Optionally, the O casing contains the W replaceable insert, enabling the assembly of various types of portable devices in the O casing. Also, the O casing is optionally equipped with the K small flap, protecting the U portable devise, in which, alternatively, there is the A antennae. By the T grip, the O casing is connected with the R grip, in which the B batteries are located, along with the indispensable P switches as well as, optionally, with the D light-emitting diodes, indicating the operation condition or mode. Optionally, the T grip enables the adjustment of the R handle positioning in relation to the O casing. The O casing contains optionally the U portable device G extension sockets or, alternatively, the G extension sockets are located in the W insert. Optionally, the B batteries also serve as additional supply for the U portable device. Optionally, he O casing is equipped i n additional joints, allowing for connecting to the computer, external supply source, or installation in a special stand.

For the operation of the RFID modular reader, it is necessary to put the U portable devise into the O casing that, when inserted properly, communicates with the C reader. The U portable devise possesses special software, operating the C reader. Optionally, the P buttons serve the purpose of switching on the C reader supply from the B battery and—optionally—initiating the data exchange with the RFID card. Other functionality, depending on the software installed, is available through the U portable devise interfaces.

The implementation of the invention provides more comfort and lowers the costs of implementing the RFID radio identification systems. The usage of the popular portable devises also has a significant impact on decreasing the operational costs and the reader extension possibilities.

1. The RFID modular reader for reading out and, optionally, recording information in the non-contact RFID cards, using portable devises as the central unit, characterized in that modular structure, consisting of the (O) casing for the (U) portable devise, containing optionally the (C) replaceable reader module, connected thereto, along with the (A) antennae, optionally with the (K) small flap, protecting the (U) portable devise as well as connected with the (O) casing by means of the (R) handle (T) grip, holding the container for (B) batteries and (P) switches.

2. The reader according to claim 1, characterized in that the movable (T) grip, allowing for adjusting the (r) handle location in relation to the (O) casing.

3. The reader according to claim 1, characterized in that the (A) antennae being fixed in the (K) small flap.

4. The reader according to claim 1, characteristic of the (B) batteries supplying the (C) RFID reader and—optionally—the (U) portable devise.

5. The reader according to claim 1, characterized in that the (O) casing simultaneously containing the (G) portable devise extension sockets, mediating in connecting other external devises.

6. The reader according to claim 1, characterized in that being equipped with additional joints, allowing for connecting to the computer, external supply source, or the stand with such terminals.

7. The reader according to claim 1, characterized in that the (R) handle or (O) casing, additionally containing the light-emitting diodes, indicating the module operational condition or mode.

8. The reader according to claim 1, characterized in that the fact that the portable devise is made up of the PDA type devise, the cell phone or smartphone, each equipped in joints allowing for connecting the external devices.

9. The reader according to claim 1, characterized in that the casing containing a replaceable insert, adjusted to the type of the (U) portable device used. However, the (W) insert optionally contains the (G) extension sockets.
